(19) United States
(12) Patent Application Publication
(10) Pub. No.: US 2026/0338694 A1
(43) Pub. Date: Oct. 29, 2026

(54) SYSTEMS AND TECHNIQUES FOR CONTROLLING DOSAGES OF MULTIPLE CHEMICALS IN MEMBRANE SEPARATION SYSTEMS

(71) Applicant: Ecolab USA Inc., Saint Paul, MN (US)

(72) Inventors: Seong-Hoon Yoon, Naperville, IL (US); Harshada Ramesh Lohokare, Pune (IN)

(21) Appl. No.: 19/656,820

(22) Filed: Apr. 23, 2026

Related U.S. Application Data
(60) Provisional application No. 63/794,215, filed on Apr. 24, 2025.

(51) Int. Cl. G01N 21/64; B01D 61/02; B01D 61/08; B01D 61/12

(52) U.S. Cl. CPC G01N 21/6428; B01D 61/025; B01D 61/08; B01D 61/12; G01N 2021/6419; G01N 2021/6441

(57) ABSTRACT

A method for controlling addition of multiple chemical additives into a membrane separation process can involve introducing first and second membrane treatment liquids into a feed stream of a membrane separation process. The first and second membrane treatment liquids can include first and second membrane treatment chemicals and first and second inert tracers, respectively. The amount of each inert tracer is proportional to a concentration of a corresponding membrane treatment chemical, and the second inert tracer is different than the first inert tracer. The method can involve fluorometrically analyzing the feed steam to determine a concentration of the first and second membrane treatment chemicals and controlling delivery of the membrane treatment liquids based on the measured concentrations.

### RELATED APPLICATION

This application claims priority to U.S. Provisional Application No. 63/794,215, filed Apr. 24, 2025, the entire contents of which are hereby incorporated by reference.

### TECHNICAL FIELD

This disclosure relates to membrane systems and, more particularly, to the control of multiple chemicals delivered to membrane systems.

### BACKGROUND

Membrane separation is a technology that selectively separates materials via pores and/or minute gaps in the molecular arrangement of a continuous membrane structure. Membrane separations can be classified by pore size and by the separation driving force. Example membrane separation techniques include microfiltration (MF), ultrafiltration (UF), ion-exchange (IE), nanofiltration (NF), and reverse osmosis (RO). For example, reverse osmosis is widely used in water purification processes to remove ions, bacteria, and other molecules and larger particles from the water. In a reverse osmosis process, an applied pressure is used to overcome an osmotic pressure across the membrane, allowing substantially pure solvent (e.g., water) to pass through the membrane while a residual solute is retained on the pressurized side of the membrane.

In practice, the degree of purification achieved using the membrane separation process is dictated, at least in part, by the quality and integrity of the membrane used in the process. If there are chemical and/or mechanical failures to the membrane structure, impurities can pass through the membrane breach and into the resulting “purified” product stream. In the case of water purification, harmful impurities and pathogens (e.g., waterborne enteric viruses, Cryptosporidium, Giardia cysts, nanoparticles, organic compounds, and so forth), which can be in the nanosize range, can pass through the membrane breach into the clean water stream, potentially creating health risks.

Foulant formation on a membrane can impact the quality of a membrane separation process. One type of foulant experienced in membrane separation process is biofouling. Biofouling can occur when microbes grow on the surface of the membrane. Another type of foulant experienced in membrane separation processes is scale fouling. Scale fouling is a type of fouling that occurs when solid salts, oxides, and hydroxides crystallize and build up on a surface. When fouling occurs on surface of a reverse osmosis membrane or nanofiltration membrane, the fouling can negatively impact the osmotic pressure of the membrane. Fouling can also reduce the flow rate and quality of the water produced by the membrane. As a result, during the operation of the membrane system, one or more chemicals may be applied to control fouling. For example, when attempting to control multiple different foulants, multiple different chemicals may be supplied to the membrane to inhibit and/or reduce the formation of each foulant on the surface of the membrane.

### SUMMARY

In general, this disclosure is directed to systems and techniques for controlling the addition of multiple different treatment chemicals to a membrane separation process. The membrane separation process may utilize a feed stream that contacts a membrane to produce a permeate stream in a concentrate stream. In some examples, the described systems and techniques are used to control addition of multiple different treatment liquids. Each treatment liquid can include a treatment chemical having a functional impact on the performance of the membrane (e.g., by inhibiting the formation of and/or reducing the presence of a foulant, such as a biofoulant and scale foulant). Each treatment liquid can also include an inert tracer present in an amount proportional to the concentration of the treatment chemical in the liquid. The inert tracer in each of the multiple different liquids can be different than each other inert tracer in the liquids, e.g., such that each inert tracer provides a discriminated optical response. The feed stream containing the multiple different treatment liquids can be fluorometrically analyzed to generate a fluorometric response from each of the different inert tracers. This can then be used to determine the concentration of each treatment chemical in the feed stream which, in turn, can be used to adjust the addition of one or more treatment chemical to meet one or more concentration targets.

In practice, it can be difficult to supply multiple different treatment liquids to a membrane separation system with controlled concentration accuracy. Operators using a dosing pump to control the feed rate of a treatment liquid supplied to a feed stream, and correspondingly the concentration of a treatment chemical in the feed stream, may be susceptible to undetected dosing errors. This can occur if the chemical supply container feeding the dosing pump runs out of product, there is a line plugging problem, or other chemical feed issues arise.

In accordance with examples of the present disclosure, systems and techniques can be implemented to determine the actual concentration of multiple different treatment chemicals in the feed stream for the membrane. If pump or chemical supply issues arise, the issue can be detected based on a change in the concentration of the treatment chemical measured in the feed stream itself. The concentration of the chemical in the feed stream can be controlled based on the measurement, helping to ensure that the chemical remains at an appropriate concentration level. By measuring and controlling the concentration of multiple different treatment chemicals using multiple different corresponding inert tracers, the measurement interference between the different dosed chemicals can be avoided (e.g., overlapping conductivity signals; inaccurate fluorescence signals when dosing chemicals with the same tracer serially in a short supply line with limited mixing).

In one example, a method for controlling addition of multiple chemical additives into a membrane separation process. The method includes introducing a first membrane treatment liquid into a feed stream of a membrane separation process and introducing a second membrane treatment liquid into the feed stream of the membrane separation process. The first membrane treatment liquid includes a first membrane treatment chemical and a first inert tracer, where an amount of the first inert tracer is proportional to a concentration of the first membrane treatment chemical. The second membrane treatment liquid includes a second membrane treatment chemical and a second inert tracer, where an amount of the second inert tracer is proportional to a concentration of the second membrane treatment chemical and the second inert tracer is different than the first inert tracer. The example method includes fluorometrically analyzing the feed steam to generate a fluorometric response of the first inert tracer and a fluorometric response of the second inert tracer, determining the concentration of the first membrane treatment chemical in the feed stream based on the fluorometric response of the first inert tracer, and determining the concentration of the second membrane treatment chemical in the feed stream based on the fluorometric response of the second inert tracer. The method further involves contacting a membrane in the membrane separation process with the feed stream containing the first membrane treatment chemical and the second membrane treatment chemical, thereby generating a permeate stream and a concentrate stream.

In another example, a method for controlling addition of multiple chemical additives into a membrane separation process. The method includes introducing a first membrane treatment liquid into a feed stream of a membrane separation process and introducing a second membrane treatment liquid into the feed stream of the membrane separation process. The first membrane treatment liquid includes a biocide and a first inert tracer, where an amount of the first inert tracer is proportional to a concentration of the biocide. The second membrane treatment liquid includes an antiscalant and a second inert tracer, where an amount of the second inert tracer is proportional to a concentration of the antiscalant and the second inert tracer is different than the first inert tracer. The example method includes fluorometrically analyzing the feed steam to generate a fluorometric response of the first inert tracer and a fluorometric response of the second inert tracer, determining the concentration of the biocide in the feed stream based on the fluorometric response of the first inert tracer, and determining the concentration of the antiscalant in the feed stream based on the fluorometric response of the second inert tracer. The method also includes controlling introduction of the first membrane treatment liquid to the feed stream based on a determined concentration of the biocide and controlling introduction of the second membrane treatment liquid to the feed stream based on a determined concentration of the antiscalant. The method further includes contacting a reverse osmosis membrane in the membrane separation process with the feed stream containing the biocide and the antiscalant, thereby generating a permeate stream and a concentrate stream.

In another example, a system is described that includes at least one pump configured to introduce a first membrane treatment liquid and a second membrane treatment liquid into a feed stream of a membrane separation process. According to the example, the first membrane treatment liquid includes a first membrane treatment chemical and a first inert tracer, the second membrane treatment liquid includes a second membrane treatment chemical and a second inert tracer, and the second inert tracer is different than the first inert tracer. The example system also includes a membrane, at least one fluorometer, and a controller. The membrane is configured to separate the feed stream into a permeate stream and a concentrate stream. The fluorometer is configured to fluorometrically analyze the feed stream to generate a fluorometric response of the first inert tracer and a fluorometric response of the second inert tracer. The controller is communicatively coupled to the pump and the fluorometer. According to the example, the controller is configured to determine a concentration of the first membrane treatment chemical in the feed stream based on the fluorometric response of the first inert tracer and determine a concentration of the second membrane treatment chemical in the feed stream based on the fluorometric response of the second inert tracer. The controller is also configured to control the pump to adjust an addition rate of the first membrane treatment liquid to the feed stream based on a determined concentration of the first membrane treatment chemical and to adjust an addition rate of the second membrane treatment liquid to the feed stream based on a determined concentration of the second membrane treatment chemical.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual diagram illustrating an example membrane separation system in which multiple liquids are controllable added to a feed stream.

FIG. 2 is a block diagram illustrating an example configuration of a fluorometer that can be used in the membrane separation system of FIG. 1.

FIG. 3 is a flow diagram illustrating an example technique that can be performed according to the disclosure

FIG. 4 is a plot showing inert tracer fluorometric response wavelengths at different excitation wavelengths for three example inert tracers.

### DETAILED DESCRIPTION

This disclosure is generally directed to systems and technique for controlling addition of multiple chemical additives to a membrane separation process having one or more membrane separation devices. The membrane separation device may be a reverse osmosis membrane (RO), a nanofiltration membrane (NF), or other type of membrane separation device, such as an ultrafiltration membrane (UF), microfiltration membrane (MF) and/or electrodialysis (ED) membrane. The form of the membrane is not limited, and any type of membrane module may be used such as spiral wound type membrane module, hollow-fiber membrane module, tubular type membrane module, and plane type membrane module. Although the membrane separation process can be used for any desired application, the separation process may commonly be deployed for water treatment and the preparation of water such as drinking water, pure water, ultra-pure grade water, process water for electricity, electronic and/or semiconductor industries, process water for the medical field, water for agents, water for injection, aseptic pyrogen-free pure water, process water of food and beverage uses, water for a boiler, and/or water for washing and cooling. A membrane separation processes can also be applied to fields such as the desalination of seawater or brackish water.

In water treatment applications, a polluting substance, solubilized substance, and/or ionic substance existing in the water to be treated may be separated using the above various kinds of membrane separation devices. In operation, various types of foulants may deposit on the piping line and/or on the surface of membrane in the membrane separation device. Example fouling that may be experienced includes biofouling (e.g., caused by microbes forming a biofilm), scale fouling (e.g., caused solid salts, oxides, and/or hydroxides crystallize and build up), and/or corrosion fouling (e.g., caused by metal corrosion). In either case, fouling can influence the osmotic pressures between two sides of the membrane. This can impact the water yield passing through the membrane, block the membrane, and/or deteriorate the efficiency of the treatment for impurities.

In general, this disclosure describes systems and techniques for controlling the addition of multiple treatment liquids to the water upstream of a membrane separation device. The different treatment liquids can be added to the feed water together (e.g., in a single injection point), in parallel (e.g., through multiple injection points at the same location along the feed stream), and/or in series (e.g., through multiple injection points at different location along the feed stream). In either case, each treatment liquid can include a treatment chemical having a functional impact on the performance of the membrane (e.g., by inhibiting the formation of and/or reducing the presence of a foulant, such as a biofoulant and scale foulant). Each treatment liquid can also include an inert tracer present in an amount proportional to the concentration of the treatment chemical in the liquid. The inert tracer in each of the multiple different liquids can be different than each other inert tracer in the liquids, e.g., such that each inert tracer provides a discriminated optical response. The feed stream containing the multiple different treatment liquids can be fluorometrically analyzed to generate a fluorometric response from each of the different inert tracers. This can then be used to determine the concentration of each treatment chemical in the feed stream which, in turn, can be used to adjust the addition of one or more treatment chemical to meet one or more concentration targets.

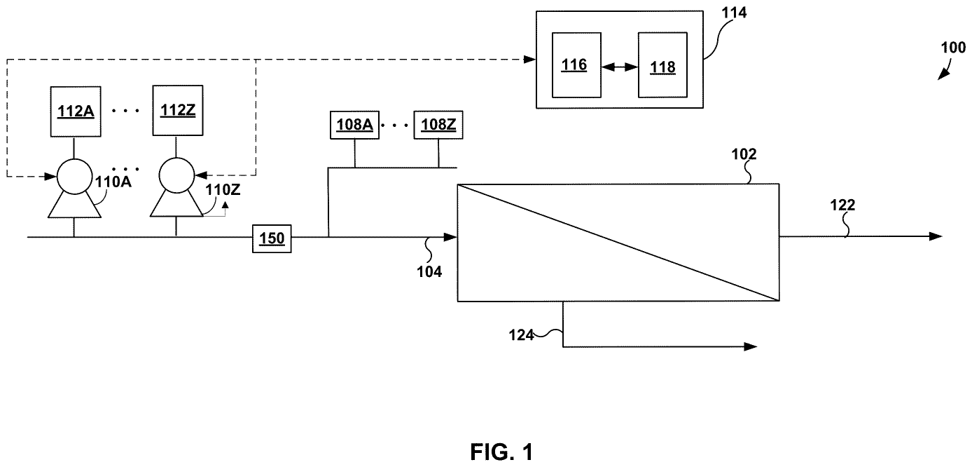

FIG. 1 is a conceptual diagram illustrating an example membrane separation system 100 in which multiple liquids are controllable added to a feed stream. System 100 includes a separation membrane 102 that receives a feed stream via a fluid pathway 104. System 100 also includes one or more pumps 110A-110Z (collectively referred to as “pump 110”) fluidly connected to one or more reservoirs 112A-112Z (collectively referred to as “reservoir 112) of treatment liquid to be introduced into the feed stream. In the illustrated example, one or more fluorometric sensors 108A-108Z (collectively referred to as “sensor 108” or “fluorometer 108”) are positioned downstream of an introduction location of the multiple treatment liquids and configured to measure a fluorometric response of the feed stream. Pump 110 can pump the treatment liquids into the feed stream based on a concentration of the treatment chemicals measured by sensor 108. A controller 114 can be communicatively coupled to various components within membrane separation system 100 to manage the overall system.

For example, controller 114 can be communicatively connected to sensor 108, pump 110, and optionally any other controllable components or sensors that may be desirably implemented in system 100. Controller 114 can include processor 116 and memory 118. Controller 114 can communicate with controllable components in system 100 via connections. For example, signals generated by sensor 108 may be communicated to controller 114 via a wired or wireless connection, which in the example of FIG. 1 is illustrated as a wired connection. Memory 118 can store software for running controller 114 and may also store data generated or received by processor 116, e.g., from sensor 108. Processor 116 can run software stored in memory 118 to manage the operation of system 100.

As described in greater detail below, multiple treatment liquids can be delivered to the feed stream supplied to separation membrane 102 via fluid pathway 104 by controlling the addition of the treatment chemicals via pump 110. Each treatment liquid can include a functional treatment chemical and an inert tracer, with different treatment liquids having different (e.g., unique) inert tracers. Operating under the control of controller 114, sensor 108 can fluorometrically analyze the feed steam to generate a fluorometric response associated with the different inert tracers associated with each of multiple different treatment chemicals. Controller 114 can determine a concentration of each of the multiple different treatment chemicals based on the fluorometric response of the inert tracers present in the feed stream and associated with the different treatment chemicals. Controller 114 may control pump 110 to adjust an addition rate of one or more of the treatment liquids based on a measured concentration of treatment chemical in the treatment liquid.

During operation of system 100, membrane 102 can be contacted with fluid to be purified from a source to remove ion, molecules, pathogens, and/or other particulate contaminants. For example, a feed stream flowing through fluid pathway 104 to membrane 102 can contain various solutes, such as dissolved organics, dissolved inorganics, dissolved solids, suspended solids, the like or combinations thereof. Membrane 102 can treat or purify the feed stream supplied to the membrane by dividing the feed stream into at least a first stream and a second stream, such as a permeate stream 122 and a concentrate stream 124 (which may also be referred to as a reject stream).

Upon separation of the feed stream into permeate stream 122 and concentrate stream 124, in membrane 102, the permeate stream can contain a substantially lower concentration of dissolved and/or suspended solutes as compared to the feed stream. On the other hand, the concentrate stream 124 can have a higher concentration of dissolved and/or suspended solutes as compared to the feed stream. In this regard, the permeate stream 122 represents a purified feed stream, such as a purified aqueous feed stream.

System 100 and membrane 102 can be configured for any desired type of membrane separation process, including cross flow separation processes, dead-end flow separation processes, reverse osmosis, ultrafiltration, microfiltration, nanofiltration, electrodialysis, electrodeionization, pervaporation, membrane extraction, membrane distillation, membrane stripping, membrane aeration and the like or combinations thereof. Typically, however, system 100 and membrane 102 may be implemented as a reverse osmosis, ultrafiltration, microfiltration, or nanofiltration membrane separation process.

In reverse osmosis, the feed stream is typically processed under cross flow conditions. When so configured, the feed stream may flow substantially parallel to the membrane surface such that only a portion of the feed stream diffuses through the membrane as permeate. The cross flow rate is typically high in order to provide a scouring action that lessens membrane surface fouling. This can also decrease concentration polarization effects (e.g., concentration of solutes in the reduced-turbulence boundary layer at the membrane surface, which can increase the osmotic pressure at the membrane and thus can reduce permeate flow). The concentration polarization effects can inhibit the feed stream water from passing through the membrane as permeate, thus decreasing the recovery ratio, e.g., the ratio of permeate to applied feed stream. A recycle loop(s) may be employed to maintain a high flow rate across the membrane surface.

System 100 can employ a variety of different types of membranes as membrane 102. Such commercial membrane element types include, without limitation, hollow fiber membrane elements, tubular membrane elements, spiral-wound membrane elements, plate and frame membrane elements, and the like. For example, reverse osmosis typically uses spiral wound elements or modules, which are constructed by winding layers of semi-porous membranes with feed spacers and permeate water carriers around a central perforated permeate collection tube. Typically, the modules are sealed with tape and/or fiberglass over-wrap. The resulting construction may have one channel that can receive an inlet flow. The inlet stream flows longitudinally along the membrane module and exits the other end as a concentrate stream. Within the module, water can pass through the semi-porous membrane and is trapped in a permeate channel, which flows to a central collection tube. From this tube it can flow out of a designated channel and is collected.

In different applications, membrane 102 can be implemented using a single membrane element or multiple membrane elements depending on the application. For example, multiple membrane elements may be used forming membrane modules that are stacked together, end to end, with inter-connectors joining the permeate tubes of the first module to the permeate tube of the second module, and so on. These membrane module stacks can be housed in pressure vessels. Within the pressure vessel, the feed stream can pass into the first module in the stack, which removes a portion of the water as permeate water. The concentrate stream from the first membrane can then become the feed stream of the second membrane and so on down the stack. The permeate streams from all of the membranes in the stack can be collected in the joined permeate tubes.

Within most reverse osmosis systems, pressure vessels may be arranged in either “stages” or “passes.” In a staged membrane system, the combined concentrate streams from a bank of pressure vessels can be directed to a second bank of pressure vessels where they become the feed stream for the second stage. Commonly, systems have two to three stages with successively fewer pressure vessels in each stage. For example, a system may contain four pressure vessels in a first stage, the concentrate streams of which feed two pressure vessels in a second stage, the concentrate streams of which in turn feeds one pressure vessel in the third stage. This is designated as a “4:2:1” array. In a staged membrane configuration, the combined permeate streams from all pressure vessels in all stages may be collected and used without further membrane treatment. Multi-stage systems are commonly used when large volumes of purified water are required, for example for boiler feed water. The permeate streams from the membrane system may be further purified by ion exchange or other means.

In a multi-pass system, the permeate streams from each bank of pressure vessels are collected and used as the feed to the subsequent banks of pressure vessels. The concentrate streams from all pressure vessels can be combined without further membrane treatment of each individual stream. Multi-pass systems are typically used when very high purity water is required, for example in the microelectronics or pharmaceutical industries. When system 100 is implemented as a reverse osmosis process, one or more membranes 102 may be configured as a multi-stage and/or multi-pass system.

While system 100 and membrane 102 may be implemented as cross-flow filtration process, in other configurations, the system may be arranged for conventional filtration of suspended solids by passing the feed stream through a filter media or membrane in a substantially perpendicular direction. This arrangement can create one exit stream (e.g., purified stream 122) during the service cycle. Periodically, the filter may be backwashed by passing a clean fluid in a direction opposite to the feed, generating a backwash effluent containing species that have been retained by the filter. In this arrangement, system 100 may have a feed stream, a purified stream, and a backwash stream. This type of membrane separation is typically referred to as dead-end flow separation and is typically limited to the separation of suspended particles greater than about one micron in size.

A variety of different treatment liquids can be supplied to the feed stream for membrane 102. Each treatment liquid can include a treatment chemical having a functional impact on the performance of the membrane (e.g., by inhibiting the formation of and/or reducing the presence of a foulant). Each treatment liquid can also include an inert tracer present in an amount proportional to the concentration of the treatment chemical in the liquid. Example treatment chemicals that can be supplied to the feed stream of membrane 102 through corresponding treatment liquids include, but are not limited to, a biocide, an antiscalant, a corrosion inhibitor, an acid, a base, an inline cleaner, and combinations thereof. The number of treatment liquids (and corresponding treatment chemicals) supplied to the feed stream for membrane 102 is at least two (e.g., such as two, three, four, or more). Accordingly, membrane separation system 100 may be configured to introduce at least a first membrane treatment liquid (containing a first membrane treatment chemical) and a second membrane treatment liquid (containing a second membrane treatment chemical) into the feed steam for membrane 102. In some examples, the first membrane treatment chemical is a biocide and the second membrane treatment chemical is an antiscalant, although additional or different combinations of membrane treatment chemicals can be used without departing from the scope of the disclosure.

When a biocide is used as one of the multiple different treatment chemicals, any suitable biocide or combination of biocides can be used. The biocide may be or include an oxidizing biocide and/or a non-oxidizing biocide, which in each case may include a halogen such as bromine or chlorine. Example chlorine and bromine-type oxidizers that be used as the biocide include: chlorine, chlorine dioxide, hypochlorous acid and the salts thereof, chlorous acid and the salts thereof, chloric acid and the salts thereof, perchloric acid and the salts thereof, chlorinated isocyanuric acid and the salts thereof, hypobromous acid and the salts thereof, bromous acid and the salts thereof, bromic acid and the salts thereof, perbromic acid and the salts thereof, brominated isocyanuric acid and the salts thereof, and combination thereof. As salts, the alkali metal salts of hypochlorous acid and hypobromous acid such as sodium hypochlorite, sodium hypobromite, potassium hypochlorite and potassium hypobromite; the alkaline earth metal salts of hypochlorous acid and hypobromous acid such as calcium hypochlorite, calcium hypobromite, barium hypochlorite and barium hypobromite; the alkali metal salts of chlorous acid and bromous acid such as sodium chlorite, sodium bromite, potassium chlorite and potassium bromite; the alkaline earth metal salts of chlorous acid and bromous acid such as calcium chlorite, calcium bromite, barium chlorite and barium bromite; other metal salts of chlorous acid and bromous acid such as nickel chlorite; ammonium chlorate and ammonium bromate; the alkali metal salts of chloric acid and bromic acid such as sodium chlorate, sodium bromate, potassium chlorate and potassium bromate; the alkaline earth metal salts of chloric acid and bromic acid such as calcium chlorate, calcium bromate, barium chlorate and barium bromate can be listed. One of these chlorine and bromine-type oxidizers can be used alone or two or more of these chlorine and bromine-type oxidizers can be combined to use.

Example non-oxidizing biocides that may be used as the biocide include bromine-containing biocides, such as 2,2-dibromo-3-nitrilopropionamide (DBNPA) and 2-bromo-2-nitro-1,3-propanediol (“bronopol”). Other example non-oxidizing biocides that may be used as a biocide include isothiazolone and glutaldehyde.

In some examples, the biocide is selected from the group consisting of chlorine, chlorine dioxide, chloramine (e.g., monochoramine), bromine, stabilized bromine, and combinations thereof. A stabilized bromine can be bromine combined with one or more of sulfamic acid, cyauric acid, ammonia, and dimethylhydantoin, including combinations thereof.

When an antiscalant (which can also be referred to as a scale inhibitor) is used as one of the multiple different treatment chemicals, any suitable antiscalant or combination of antiscalants can be used. The antiscalant may be or include phosphates, phosphate esters, phosphoric acids, phosphonates, phosphonic acids, polyacrylamides, salts of acrylamido-methyl propane sulfonate/acrylic acid copolymer (AMPS/AA), phosphinated maleic copolymer (PHOS/MA), and salts of a polymaleic acid/acrylic acid/acrylamido-methyl propane sulfonate terpolymer (PMA/AMPS).

In some examples, the antiscalant is or includes 1-hydroxyethylidene-1,1-diphosphonic acid (abbreviated “HEDP”), 2-Phosphonobutane-1,2,4-tricarboxylic acid (abbreviated “PBTC”), aminotri(methylenephosphonic acid (abbreviated “AMP”), hexamethylene diamine tetra(methylene phosphonic acid (abbreviated “HMDTMP”) polyamino polyether methylenephosphonic acid (abbreviated “PAPEMP”), and/or organic polymers such as polyacrylic acid, polyacrylates, polymaleic acid, maleic anhydride/ethyl acrylate/vinyl acrylate terpolymer and alkyl epoxy carboxylate (abbreviated “AEC”), phosphinocarboxylic acids, such as phosphinosuccinate oligomers (abbreviated as “PSO”), and/or phosphonocarboxylic acids, such as phosphonocarboxylic (sulfonated) copolymer (abbreviated “POCA”).

When a corrosion inhibitor is used as one of the multiple different treatment chemicals, any suitable corrosion inhibitor or combination of corrosion inhibitor can be used. The corrosion inhibitor may be or include alkyl, hydroxyalkyl, alkylaryl, arylalkyl or arylamine quaternary salts; mono or polycyclic aromatic amine salts; imidazoline derivatives; mono-, di- or trialkyl or alkylaryl phosphate esters; phosphate esters of hydroxylamines; phosphate esters of polyols; and monomeric or oligomeric fatty acids. Suitable alkyl, hydroxyalkyl, alkylaryl arylalkyl or arylamine quaternary salts include those alkylaryl, arylalkyl and arylamine quaternary salts of the formula [N⁻R^{5a}R^{6a}R^{7a}R^{8a}][X⁻] where R^{5a}, R^{6a}, R^{7a}, and R^{8a} contain one to 18 carbon atoms, and X is Cl, Br or I. In certain applications, R^{5a}, R^{6a}, R^{7a}, and R^{8a} are each independently selected from the group consisting of alkyl (e.g., C1-C18 alkyl), hydroxyalkyl (e.g., C1-C18 hydroxyalkyl), and arylalkyl (e.g., benzyl).

Suitable quaternary ammonium salts include, but are not limited to, tetramethyl ammonium chloride, tetraethyl ammonium chloride, tetrapropyl ammonium chloride, tetrabutyl ammonium chloride, tetrahexyl ammonium chloride, tetraoctyl ammonium chloride, benzyltrimethyl ammonium chloride, benzyltriethyl ammonium chloride, phenyltrimethyl ammonium chloride, phenyltriethyl ammonium chloride, cetyl benzyldimethyl ammonium chloride, hexadecyl trimethyl ammonium chloride, dimethyl alkyl benzyl quaternary ammonium compounds, monomethyl dialkyl benzyl quaternary ammonium compounds, trimethyl benzyl quaternary ammonium compounds, and trialkyl benzyl quaternary ammonium compounds, where the alkyl group can contain between about 6 and about 24 carbon atoms, about 10 and about 18 carbon atoms, or about 12 to about 16 carbon atoms. Suitable quaternary ammonium compounds (quats) include, but are not limited to, trialkyl, dialkyl, dialkoxy alkyl, monoalkoxy, benzyl, and imidazolinium quaternary ammonium compounds, salts thereof, the like, and combinations thereof. In some applications, the quaternary ammonium salt is an alkylamine benzyl quaternary ammonium salt, a benzyl triethanolamine quaternary ammonium salt, or a benzyl dimethylaminoethanolamine quaternary ammonium salt.

In some applications, the corrosion inhibitor may be an imidazoline derived from a diamine, such as ethylene diamine (EDA), diethylene triamine (DETA), triethylene tetraamine (TETA) etc. and a long chain fatty acid such as tall oil fatty acid (TOFA). The corrosion inhibitor may further be a monomeric or oligomeric fatty acid, such as C14-C22 saturated and unsaturated fatty acids as well as dimer, trimer and oligomer products obtained by polymerizing one or more of such fatty acids. The corrosion inhibitor may be a triazole. The triazole may be selected from the group consisting of: benzotriazole, tolyltriazole, butylbenzotriazole, halo-benzotriazoles, halo-tolyltriazoles, nitrated-triazoles, and combinations thereof.

Independent of the types of treatment chemicals selected to be dosed to the feed stream supplied to membrane 102, each treatment chemical is associated with a corresponding tracer. Each tracer may be a fluorescent tracer that absorbs electromagnetic radiation at one wavelength and reemits electromagnetic radiation at a different (e.g., lower energy) wavelength. Each tracer can be inert and added a known proportion to the membrane treatment chemical being traced. As used herein, “inert” means that an inert tracer (e.g., an inert fluorescent tracer) is not appreciably or significantly affected by any other chemistry or system parameters (e.g., such as pH, temperature, ionic strength, redox potential, microbiological activity, membrane treatment chemical concentration, metallurgical composition, heat changes, overall heat content). “Not appreciably or significantly affected” means that an inert fluorescent compound has no more than a 10 percent change in its fluorescent signal, under conditions encountered in the membrane separation system. There are invariably some background interferences, such as natural fluorescence in the feedwater, and in such circumstances the tracer dosage may be increased to overcome background interference, which, under classical analytical chemistry definitions, shall be less than 10%.

Example fluorescent tracers that may be used include, but are not limited to, 3,6-acridinediamine, N,N,N′,N′-tetramethyl-, monohydrochloride, also known as Acridine Orange (CAS Registry No. 65-61-2), 2-anthracenesulfonic acid sodium salt (CAS Registry No. 16106-40-4), 1,5-anthracenedisulfonic acid (CAS Registry No. 61736-91-2) and salts thereof, 2,6-anthracenedisulfonic acid (CAS Registry No. 61736-95-6) and salts thereof, 1,8-anthracenedisulfonic acid (CAS Registry No. 61736-92-3) and salts thereof, anthra[9,1,2-cde]benzo[rst]pentaphene-5,10-diol, 16,17-dimethoxy-, bis(hydrogen sulfate), disodium salt, also known as Anthrasol Green IBA (CAS Registry No. 2538-84-3, aka Solubilized Vat Dye), bathophenanthrolinedisulfonic acid disodium salt (CAS Registry No. 52746-49-3), amino 2,5-benzene disulfonic acid (CAS Registry No. 41184-20-7), 2-(4-aminophenyl)-6-methylbenzothiazole (CAS Registry No. 92-36-4), 1H-benz[de]isoquinoline-5-sulfonic acid, 6-amino-2,3-dihydro-2-(4-methylphenyl)-1,3-dioxo-, monosodium salt, also known as Brilliant Acid Yellow 8G (CAS Registry No. 2391-30-2, aka Lissamine Yellow FF, Acid Yellow 7), phenoxazin-5-ium, 1-(aminocarbonyl)-7-(diethylamino)-3,4-dihydroxy-, chloride, also known as Celestine Blue (CAS Registry No. 1562-90-9), benzo[a]phenoxazin-7-ium, 5,9-diamino-, acetate, also known as cresyl violet acetate (CAS Registry No. 10510-54-0), 4-dibenzofuransulfonic acid (CAS Registry No. 42137-76-8), 3-dibenzofuransulfonic acid (CAS Registry No. 215189-98-3), 1-ethylquinaldinium iodide (CAS Registry No. 606-53-3), fluorescein (CAS Registry No. 2321-07-5), fluorescein, sodium salt (CAS Registry No. 518-47-8, aka Acid Yellow 73, Uranine), Keyfluor White ST (CAS Registry No. 144470-48-4, aka Flu. Bright 28), benzenesulfonic acid, 2,2′-(1,2-ethenediyl)bis[5-[[4-[bis(2-hydroxyethyl)amino]-6-[(4-sulfophen-yl)amino]-1,3,5-triazin-2-yl]amino]-, tetrasodium salt, also known as Keyfluor White CN (CAS Registry No. 16470-24-9), C.I. Fluorescent Brightener 230, also known as Leucophor BSB (CAS Registry No. 68444-86-0), benzenesulfonic acid, 2,2′-(1,2-ethenediyl)bis[5-[[4-bis(2-hydroxyethyl)amino]-6-[(4-sulfophen-yl)amino]-1,3,5-triazin-2-yl]amino]-, tetrasodium salt, also known as Leucophor BMB (CAS Registry No. 16470-24-9, aka Leucophor U, Flu. Bright. 290), 9,9′-biacridinium, 10,10′-dimethyl-, dinitrate, also known as Lucigenin (CAS Registry No. 2315-97-1, aka bis-N-methylacridinium nitrate), 1-deoxy-1-(3,4-dihydro-7,8-dimethyl-2,4-dioxobenzo[g]pteridin-1-0(2H)-yl)-D-ribitol, also known as Riboflavin or Vitamin B2 (CAS Registry No. 83-88-5), mono-, di-, or tri-sulfonated napthalenes, including but not limited to 1,5-naphthalenedisulfonic acid disodium salt (hydrate) (CAS Registry No. 1655-29-4, aka 1,5-NDSA hydrate), 2-amino-1-naphthalenesulfonic acid (CAS Registry No. 81-16-3), 5-amino-2-naphthalenesulfonic acid (CAS Registry No. 119-79-9), 4-amino-3-hydroxy-1-naphthalenesulfonic acid (CAS Registry No. 90-51-7), 6-amino-4-hydroxy-2-naphthalenesulfonic acid (CAS Registry No. 116-63-2), 7-amino-1,3-naphthalenesulfonic acid, potassium salt (CAS Registry No. 79873-35-1), 4-amino-5-hydroxy-2,7-naphthalenedisulfonic acid (CAS Registry No. 90-20-0), 5-dimethylamino-1-naphthalenesulfonic acid (CAS Registry No. 4272-77-9), 1-amino-4-naphthalene sulfonic acid (CAS Registry No. 84-86-6), 1-amino-7-naphthalene sulfonic acid (CAS Registry No. 119-28-8), 2,6-naphthalenedicarboxylic acid, dipotassium salt (CAS Registry No. 2666-06-0), 3,4,9,10-perylenetetracarboxylic acid (CAS Registry No. 81-32-3), 2,6-naphthalenedisulfonic acid disodium salt (CAS Registry No. 1655-45-4), 1,5-naphthalenedisulfonic acid disodium salt (CAS Registry No. 207569-02-6), C.I. Fluorescent Brightener 191, also known as Phorwite CL (CAS Registry No. 12270-53-0), C.I. Fluorescent Brightener 200, also known as Phorwite BKL (CAS Registry No. 61968-72-7), benzenesulfonic acid, 2,2′-(1,2-ethenediyl)bis[5-(4-phenyl-2H-1,2,3-triazol-2-yl)-, dipotassium salt, also known as Phorwite BHC 766 (CAS Registry No. 52237-03-3), benzenesulfonic acid, 5-(2H-naphtho[1,2-d]triazol-2-yl)-2-(2-phenylethenyl)-, sodium salt, also known as Pylaklor White S-15A (CAS Registry No. 6416-68-8), 1,3,6,8-pyrenetetrasulfonic acid, tetrasodium salt (CAS Registry No. 59572-10-0), pyranine, (CAS Registry No. 6358-69-6, aka 8-hydroxy-1,3,6-pyrenetrisulfonic acid, trisodium salt), quinoline (CAS Registry No. 91-22-5), 3H-phenoxazin-3-one, 7-hydroxy-, 10-oxide, also known as Rhodalux (CAS Registry No. 550-82-3), xanthylium, 9-(2,4-dicarboxyphenyl)-3,6-bis(diethylamino)-, chloride, disodium salt, also known as Rhodamine WT (CAS Registry No. 37299-86-8), phenazinium, 3,7-diamino-2,8-dimethyl-5-phenyl-, chloride, also known as Safranine O (CAS Registry No. 477-73-6), C.I. Fluorescent Brightener 235, also known as Sandoz CW (CAS Registry No. 56509-06-9), benzenesulfonic acid, 2,2′-(1,2-ethenediyl)bis[5-[[4-[bis(2-hydroxyethyl)amino]-6-[(4-sulfophen-yl)amino]-1,3,5-triazin-2-yl]amino]-, tetrasodium salt, also known as Sandoz CD (CAS Registry No. 16470-24-9, aka Flu. Bright. 114), benzenesulfonic acid, 2,2′-(1,2-ethenediyl)bis[5-[[4-[(2-hydroxypropyl)amino]-6-(phenylamino)-1-,3,5-triazin-2-yl]amino]-, disodium salt, also known as Sandoz TH-40 (CAS Registry No. 32694-95-4), xanthylium, 3,6-bis(diethylamino)-9-(2,4-disulfophenyl)-, inner salt, sodium salt, also known as Sulforhodamine B (CAS Registry No. 3520-42-1, aka Acid Red 52), benzenesulfonic acid, 2,2′-(1,2-ethenediyl)bis[5-[[4-[(aminomethyl)(2-hydroxyethyl)amino]-6-(ph-enylamino)-1,3,5-triazin-2-yl]amino]-, disodium salt, also known as Tinopal 5BM-GX (CAS Registry No. 169762-28-1), Tinopol DCS (CAS Registry No. 205265-33-4), benzenesulfonic acid, 2,2′-([1,1′-biphenyl]-4,4′-diyldi-2,1-ethenediyl)bis-, disodium salt also known as Tinopal CBS-X (CAS Registry No. 27344-41-8), benzenesulfonic acid, 5-(2H-naphtho[1,2-d]triazol-2-yl)-2-(2-phenylethenyl)-, sodium salt, also known as Tinopal RBS 200, (CAS Registry No. 6416-68-8), 7-benzothiazolesulfonic acid, 2,2′-(1-triazene-1,3-diyldi-4,1-phenylene)bis[6-methyl-, disodium salt, also known as Titan Yellow (CAS Registry No. 1829-00-1, aka Thiazole Yellow G), and all ammonium, potassium and sodium salts thereof, and all like agents and suitable mixtures thereof. The inert tracer can be chemically separate from the membrane treatment chemical and added in an amount proportional to the membrane treatment chemical to the membrane treatment liquid.

In addition to the tracers listed above, those of ordinary skill in the art will recognize that salts using alternate counter ions may also be used. Thus, for example, anionic tracers, which have Na⁺ as a counter ion, could also be used in forms where the counter ion is chosen from K⁺, NH₄⁺, Ca²⁺, Mg²⁺ or other appropriate counter ions. Similarly, cationic tracers may have a variety of counter ions, for example: Cl⁻, SO₄²⁻, PO₄³⁻, HPO₄²⁻; H₂PO₄⁻; CO₃²⁻; HCO₃⁻; or other appropriate counter ions.

A different inert tracer can be selected and associated with each of the different treatment chemicals to be introduced into feed stream 104 supplied to membrane 102. The inert tracers may be different from each other by having a different chemical formulation. The inert tracers may also be different from each other by emitting electromagnetic radiation (in response to excitation energy) at different peak wavelengths. This can allow the fluorescence signal from each inert tracer to be discriminated from the fluorescence signal from each other inert tracer without interference. In turn, this can allow the concentration of each membrane treatment chemical associated with each inert tracer to be accurately determined.

For example, inert tracers may be selected to a first inert tracer emits light at a first peak wavelength and/or over a first wavelength range in response to being excited and a second inert tracer emits light at a second peak wavelength and/or over a second wavelength range in response to being excited. The wavelength(s) of light used to excite the first and second inert tracers may be the same, or the first inert tracer may be excited using a different wavelength(s) of light than the wavelength(s) of light used to exit the second inert tracer. In either case, the tracers may be selected so the first peak wavelength and/or the first wavelength range is offset from (e.g., des not overlap with) the second peak wavelength and/or the second wavelength range. In some applications, the tracers may be selected so the first peak wavelength and/or the end of the first wavelength range is offset at least 10 nm from the second peak wavelength and/or the start of the second wavelength range, such as at least 25 nm, at least 50 nm, at least 75 nm, or at least 100 nm. When using more than two membrane treatment chemicals with more than two corresponding inert tracers (e.g., three, four, or more), each inert tracer can be selected to have an offset fluorometric as discussed above with respect to two inert tracers.

With further reference to FIG. 1, system 100 includes one or more fluorometers 108 positioned to fluorometrically analyze at least a portion of feed stream 104 to generate a fluorometric response from each of the multiple inert tracers introduced into the feed stream with corresponding membrane treatment chemicals. Fluorometer 108 used in system 100 can be implemented in a number of different ways in the system. In some examples, a pipe, tube, or other conduit is connected between a fluid pathway through which feed stream 104 flows to the fluorometer, e.g., providing a slip stream or sample stream from the bulk of flowing liquid. As fluid moves through the fluid pathway, a portion of the fluid may enter the conduit and pass adjacent to and/or in contact with fluorometer 108, thereby allowing the sensor to measure a concentration of multiple inert tracers in the fluid (and, correspondingly, determine a concentration of multiple associated membrane treatment chemicals). In alternative configurations, fluorometer 108 can be positioned in-line with the fluid pathway through which flow stream 104 flows, e.g., allowing the sensor to directly sample and/or analyze the feed stream flowing through the fluid pathway without drawing a slip stream. In still other applications, fluorometer 108 may be used to analyze a stationary volume of fluid that does not flow through and/or in contact with the sensor. For example, in these alternative configurations, fluorometer 108 may be implemented as an offline monitoring tool (e.g., as a handheld sensor), that requires filling the sensor with a fluid sample manually extracted from system 100.

In general, fluorometer 108 may be positioned to measure a concentration of the multiple inert tracers associated with multiple membrane treatment chemicals at a location downstream of where the membrane treatment liquids are added to feed stream 104. In the illustrated example of FIG. 1, pump 110 is illustrated as introducing multiple membrane treatment liquids into feed stream 104 at one or more addition location 134. In various implementations, the multiple different membrane treatment liquids can be added at a single addition location (e.g., by supplying the multiple membrane treatment liquids each having a different inert tracer and membrane treatment chemical in a single reservoir 112 that pump 110 draws from) or at different additional locations that are in parallel or in series with each other along the flow path of feed stream 104.

Fluorometer 108 can measure the inert tracer concentration in the feed stream at a location downstream of the addition location(s) of the multiple membrane treatment liquids. In some examples, a mixer 150 (e.g., static mixer, driven mixer) is positioned between the additional location(s) and fluorometer 108 to intermix the added multiple membrane treatment liquids with the source water more than mixing through flow conveyance alone, helping to ensure uniform concentration distribution of the multiple membrane treatment liquids in the water before analysis by fluorometer 108. Additionally or alternatively, fluorometer 108 may analyze a portion of the feed stream at a location sufficiently far away from the addition(s) that the membrane treatment liquids have substantially uniformly distributed (e.g., mixed) throughout the feed stream before being analyzed by sensor 108. The use of different inert tracers may, however, allow fluorometer 108 to be placed closer to the addition locations than if membrane treatment liquid are serially added with the same inert tracer. In some examples, fluorometer 108 may be located 0.1 m to 10 m downstream from the last membrane treatment liquid, such as a distance less than 10 m, less than 5 m, less than 2 m, or less than 1 m.

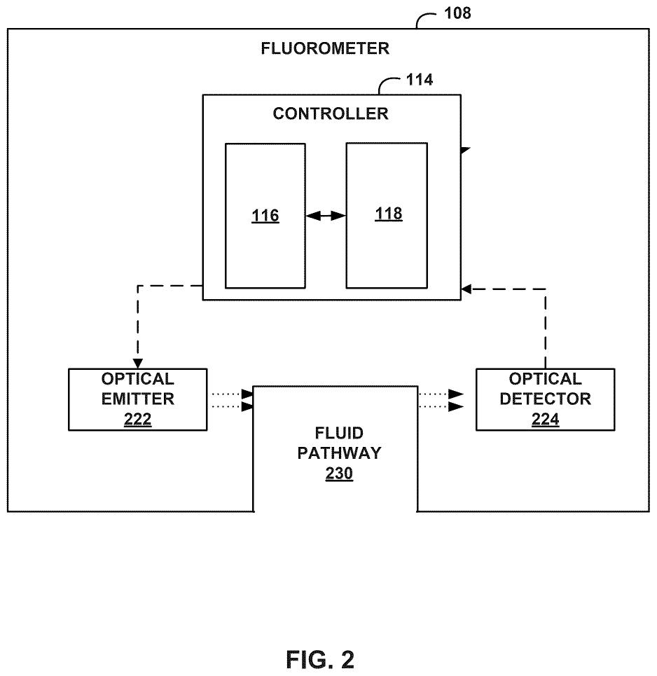

FIG. 2 is a block diagram illustrating an example configuration of a fluorometer 108 that can be used in membrane separation system 100. Sensor 200 in the illustrate example includes controller 114, one or more optical emitters 222 (referred to herein as “optical emitter 222”), and one or more optical detectors 224 (referred to herein as “optical detector 224”). Controller 114 used to control fluorometer 108 is illustrated as being the same system controller in FIG. 1 use to control membrane separation system 100, although each feature described as a controller herein can be implemented using one or more controllers operating individually or in combination and either physically co-located or remotely located from each other. In operation, optical emitter 222 can direct light into a static portion of fluid or fluid flowing through fluid channel 230 and optical detector 224 detects fluorescent emissions generated by the fluid. The light directed into the fluid by optical emitter 222 may generate fluorescent emissions by exciting electrons of fluorescing molecules (inert tracers) within the fluid, causing the molecules to emit energy (i.e., fluoresce) that can be detected by optical detector 224. For example, optical emitter 222 may direct light at one frequency (e.g., ultraviolet frequency) into fluid through fluid channel 230 and cause fluorescing molecules to emit light energy at a different frequency (e.g., visible light frequency).

Memory 118 may store data used by controller 114 to determine a concentration of each membrane treatment chemical within the fluid being monitored by sensor 108. In some examples, memory 228 stores data in the form of an equation that relates fluorescent emissions detected by optical detector 224 to the concentrations of the multiple different treatment chemicals.

Optical emitter 222 includes at least one optical emitter that emits optical energy into a fluid present with fluid channel 230. In some examples, optical emitter 222 emits optical energy over range of wavelengths. In other examples, optical emitter 222 emits optical energy at one or more discrete wavelengths. For example, optical emitter 222 may emit at two, three, four or more discrete wavelengths.

In one example, optical emitter 222 emits light within the ultraviolet (UV) spectrum. Light within the UV spectrum may include wavelengths in the range from approximately 10 nm to approximately 400 nanometers. Light emitted by optical emitter 222 is directed into fluid within fluid channel 230. In response to receiving the optical energy, fluorescing molecules within the fluid may excite, causing the molecules to produce fluorescent emissions. The fluorescent emissions, which may be at a different frequency than the energy emitted by optical emitter 222, may be generated as excited electrons within fluorescing molecules change energy states. The energy emitted by the fluorescing molecules may be detected by optical detector 224. For example, optical emitter 222 may emit light in the frequency range of approximately 250 nm to approximately 500 nm and, depending on the composition of the fluid, cause fluorescent emissions in the range of approximately 300 nm to approximately 600 nm.

Optical emitter 222 may be implemented in a variety of different ways within sensor 200. Optical emitter 222 may include one or more light sources to excite molecules within the fluid. Example light sources include light emitting diodes (LEDS), lasers, and lamps. In some examples, optical emitter 222 includes an optical filter to filter light emitted by the light source. The optical filter may be positioned between the light source and the fluid and be selected to pass light within a certain wavelength range. In some additional examples, the optical emitter includes a collimator, e.g., a collimating lens, hood or reflector, positioned adjacent the light source to collimate the light emitted from the light source. The collimator may reduce the divergence of the light emitted from the light source, reducing optical noise.

The multiple different inert tracers introduced into feed stream 104 with corresponding membrane treatment chemicals may be excited at the same wavelength (e.g., such that emission by a single optical emitter excites multiple of the inert tracers). Alternatively, multiple different inert tracers introduced into feed stream 104 with corresponding membrane treatment chemicals may be excited at different wavelengths. In these latter cases, (1) a single optical emitter may be configured to emit at multiple excitation wavelengths, (2) fluorometer 108 may be configured with multiple optical emitter 222 (arranged in series or in parallel) with each optical emitter configured to emit at a different excitation wavelength corresponding to the different inert tracers, and/or (3) system 100 may utilize multiple fluorometers 108 (e.g., arranged in series or in parallel, with the optical emitter of each of the different fluorometers configured to emit at a different excitation wavelength corresponding to the different inert tracers).

Fluorometer 108 also includes optical detector 224. Optical detector 224 includes at least one optical detector that detects fluorescent emissions emitted by excited molecules within fluid channel 230. In some examples, optical detector 224 is positioned on a different side of fluid channel 230 than optical emitter 222. For example, optical detector 224 may be positioned on a side of fluid channel 230 that is offset approximately 90 degrees relative to optical emitter 222. Such an arrangement may reduce the amount of light that is emitted optical emitter 222, transmitted through fluid within fluid channel 230, and detected by optical detector 224. This transmitted light can potentially cause interference with fluorescent emissions detected by the optical detector.

In operation, the amount of optical energy detected by optical detector 224 may depend on the concentration of each inert tracer in the fluid within fluid channel 230. For example, if a fluid within fluid channel 230 has a first concentration of an inert tracer (and, correspondingly, a first concentration of membrane treatment chemical), optical detector 224 may detect a first magnitude of fluorescent emissions. However, if the fluid within fluid channel 230 has second concentration of the inert tracer (and, correspondingly, a second concentration of membrane treatment chemical) that is greater than the first concentration, optical detector 224 may detect a second magnitude of fluorescent emissions that is greater than the first magnitude.

Optical detector 224 may also be implemented in a variety of different ways within sensor 200. Optical detector 224 may include one or more photodetectors such as, e.g., photodiodes or photomultipliers, for converting optical signals into electrical signals. In some examples, optical detector 224 includes a lens positioned between the fluid and the photodetector for focusing and/or shaping optical energy received from the fluid.

As noted, the multiple different inert tracers introduced into feed stream 104 with corresponding membrane treatment chemicals can emit at different wavelength. To detect fluorescent emissions at these different wavelengths, (1) a single optical detector may be configured to detect at multiple emission wavelengths, (2) fluorometer 108 may be configured with multiple optical detectors 224 (arranged in series or in parallel) with each optical detector configured to detect at a different emission wavelength corresponding to the different inert tracers, and/or (3) system 100 may utilize multiple fluorometers 108 (e.g., arranged in series or in parallel, with the optical detector of each of the different fluorometers configured to detect at a different emission wavelength corresponding to the different inert tracers).

In operation, controller 114 can control optical emitter 222 to direct radiation into a fluid and further control optical detector 224 to detect fluorescent emissions emitted by the inert tracers in the fluid. Controller 114 can then process the light detection information to determine a concentration of each inert tracer in the fluid and, correspondingly, the concentration of each membrane treatment chemical associated with each inert tracer. For each inert tracer, controller 114 can determine a concentration of the tracer by comparing the magnitude of fluorescent emissions detected by optical detector 224 from a fluid having an unknown concentration of the inert tracer to the magnitude of the fluorescent emissions detected by optical detector 224 from a fluid having a known concentration of the tracer. Controller 114 can determine the concentration of each membrane treatment chemical associated with each inert tracer, e.g., using Equations (1) and (2) below:

C_c=C_m×C_o/C_f Equation 1

C_m=K_m×(S_x−Z_o) Equation 2

In Equations (1) and (2) above, C_{c} is a current concentration of the membrane treatment chemical, Cₘ is a current concentration of the inert tracer associated with the membrane treatment chemical, Cₒ is a nominal concentration of the membrane treatment chemical, C_{f} is a nominal concentration of the inert tracer associated with the membrane treatment chemical, Kₘ is a slope correction coefficient, Sₓ is a current fluorescent measurement signal, and Zₒ is a zero shift. Controller 114 may further adjust the determined concentration of the membrane treatment chemical based on temperature measured by a temperature sensor (e.g., associated with fluorometer 108).

With further reference to FIG. 1, controller 114 can control the addition of each membrane treatment chemical to feed stream 104 based on a target concentration for each membrane treatment chemical and a measured concentration of each membrane treatment chemical measured by fluorometer 108. Controller 114 can compare the concentration of each membrane treatment chemical in feed stream 104 measured by fluorometer 108 to the concentration for that membrane treatment chemical (e.g., stored in memory 118). Based on the comparison, controller 114 can control pump 112 to adjust an addition rate of the membrane treatment liquid (containing the membrane treatment chemical and the associated inert tracer) to flow stream 104. In different examples, controller 114 may control pump 110 to start the pump, to stop the pump, or to increase or decrease an addition rate of the membrane treatment chemical provided by pump 110 relative to a baseline introduction rate.

In some examples, controller 114 is provided with a target concentration for each membrane treatment chemical against which the concentration measured by fluorometer 108 is compared. For example, controller 114 may be informed of a target concentration for each membrane treatment chemical from a user via a user interface (which can be physically coupled to or remote from and communicatively coupled to controller 114). Controller 114 may be informed of the target concentration for each membrane treatment chemical in the feed stream in various ways. The target concentration may be programmed into the controller at manufacturing or set up, and/or once deployed within system 100. Controller 114 may be informed of the target concentration from a user via a user interface communicatively coupled to the controller (e.g., on-site or from a location remote from where the controller is located) or may receive information concerning the target concentration from one or more other systems or sensors within the operating environment where system 100 is located.

In some examples, the amount of inert tracer associated with each membrane treatment chemical is at least sufficient to provide a measurable concentration in flow stream 104. Example doses range for each inert tracer once added to and diluted by flow stream 104 may be in a range from about 50 ppt (parts per trillion) to about 100 ppb (parts per billion), such as from about 0.1 ppb to about 10 ppb, based on inert tracer concentration.

The tracer may constitute from about 0.001 wt % to about 10 wt % of each membrane treatment liquid composition, such as from about 0.01 wt % to about 5 wt %, or from about 0.1 wt % to about 3 wt %. The membrane treatment chemical may constitute a remainder weight percentage of the membrane treatment liquid, or further active and/or inactive ingredients may be included in the membrane treatment liquid.

Reservoir 112 supplying the membrane treatment liquids can be any type of source reservoir including, e.g., a pail, a drum, a cylinder, a tote, solid feeder system, and/or a hands-free delivery chemical delivery system, such as PORTA-FEED® from Nalco, an Ecolab Company. The reservoir may store a liquid, a solid (e.g., powder), and/or a gas. In examples in which the membrane treatment liquid is provided in a solid and/or gaseous form, pump 110 may be replaced with a different type of metering device configured to deliver the gas and/or solid chemical agent to an intended discharge location.

System 100 can be used to purify any desired type of fluid. Example aqueous (water-based) liquid feed sources that may be purified using system 100 include raw water streams (e.g., extracted from a fresh water source), waste water and recycle water streams (e.g., from municipal and/or industrial sources), streams in food and beverage processes, streams in pharmaceutical processes, streams in electronic manufacturing, streams in utility operations, streams in pulp and paper processes, streams in mining and mineral processes, streams in transportation-related processes, streams in textile processes, streams in plating and metal working processes, streams in laundry and cleaning processes, streams in leather and tanning processes, streams in paint processes, and combinations thereof. Liquid from the source may include microorganisms that have a tendency to cause fouling in system 100, such as bacteria (e.g., Legionella, Shigella, Escherichia coli, Vibrio, Salmonella, Mycobacterium, Pseudomonads), viruses (e.g., Norwalk virus, rotaviruses), protozoans (e.g., Entamoeba, Giardia, Cryptosporidium), and combinations thereof.

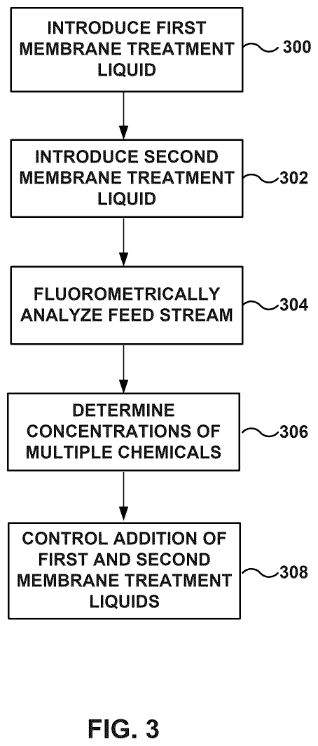

FIG. 3 is a flow diagram illustrating an example technique that can be performed according to the disclosure. The technique of FIG. 3 will be described with respect to membrane separation system 100 of FIG. 1, although can be implemented using other system arrangements as described herein.

The example technique of FIG. 3 includes introducing a first membrane treatment liquid into a feed stream of a membrane separation process (step 300). For example, operating under the control of controller 114, a first pump 110 can draw a first membrane treatment liquid from a first reservoir 112 and introduce the membrane treatment liquid into a static or flowing volume of liquid to be separated by membrane 102. The first membrane treatment liquid can include a first membrane treatment chemical (e.g., a biocide or antiscalant) and a first inert tracer mixed therewith. The first inert tracer can be present in the first membrane treatment liquid in a known amount proportional to the amount of the first membrane treatment chemical present in the membrane treatment liquid.

The example technique of FIG. 3 also includes introducing a second membrane treatment liquid into a feed stream of a membrane separation process (step 302). For example, operating under the control of controller 114, a second pump 110 can draw a second membrane treatment liquid from a second reservoir 112 and introduce the membrane treatment liquid into a static or flowing volume of liquid to be separated by membrane 102. The second membrane treatment liquid can be introduced at the same location as the first membrane treatment liquid is introduced into the water supplied to membrane 102 (e.g., simultaneous therewith) or at different location upstream, downstream, or co-located with the location at which the first membrane treatment liquid is introduced. In either case, the second membrane treatment liquid can include a second membrane treatment chemical (e.g., a biocide or antiscalant) and a second inert tracer mixed therewith. The second inert tracer can be present in the second membrane treatment liquid in a known amount proportional to the amount of the second membrane treatment chemical present in the membrane treatment liquid.

The example technique can include fluorometrically analyzing the feed stream (e.g., a portion or entirety of the water with multiple membrane treatment liquids added thereto) to generate a fluorometric response of multiple different tracers in the water (step 304). The first and second inert tracers can be selected to be different tracers each providing a different and distinguishable fluorometric response. For example, the first inert tracer may emit light at one or more wavelengths in response to being excited, and the second inert tracer may emit light at one or more different wavelengths in response to being excited. The first inert tracer may emit light at a wavelength (e.g., peak) that is different than the wavelength (e.g., peak) at which the second inert tracer emits, providing a discriminable fluorescent signal between the two or more inert tracers.

In the example technique, controller 114 can determine a concentration of the first membrane treatment chemical in the feed stream based on the fluorometric response of the first inert tracer and also determine the concentration of the second membrane treatment chemical in the feed stream based on the fluorometric response of the second inert tracer (step 308). With reference to memory 118, controller 114 can compare the fluorometric response of the first and second inert tracers to the fluorometric response of the tracers at a known concentration and determine therefrom the actual concentration of the first and second inert tracers in the flow stream. Controller 114 can further determine the concentration of the first and second membrane treatment chemicals based on the determined concentration of the first and second inert tracers in the flow stream and information specifying the proportional amount of each tracer to a corresponding membrane treatment chemical.

In the example of FIG. 3, the example technique further includes controlling pump 112 to control the amount of the first membrane treatment liquid based on the determined concentration of the first membrane treatment chemical in the flow stream and/or to control the amount of the second membrane treatment liquid based on the determined concentration of the second membrane treatment chemical in the flow stream (step 308). Controller 114 can compare the determined concentration of the first membrane treatment chemical to one or more first membrane treatment chemical concentration thresholds. Additionally or alternatively, controller 114 can compare the determined concentration of the second membrane treatment chemical to one or more second membrane treatment chemical concentration thresholds. Controller 114 can increase the amount of the first and/or second membrane treatment liquid supplied to the flow stream if the determined concentration of the first and/or second membrane treatment chemical is below a corresponding concentration threshold. Additionally or alternatively, controller 114 can decrease the amount of the first and/or second membrane treatment liquid supplied to the flow stream if the determined concentration of the first and/or second membrane treatment chemical is below a corresponding concentration threshold.

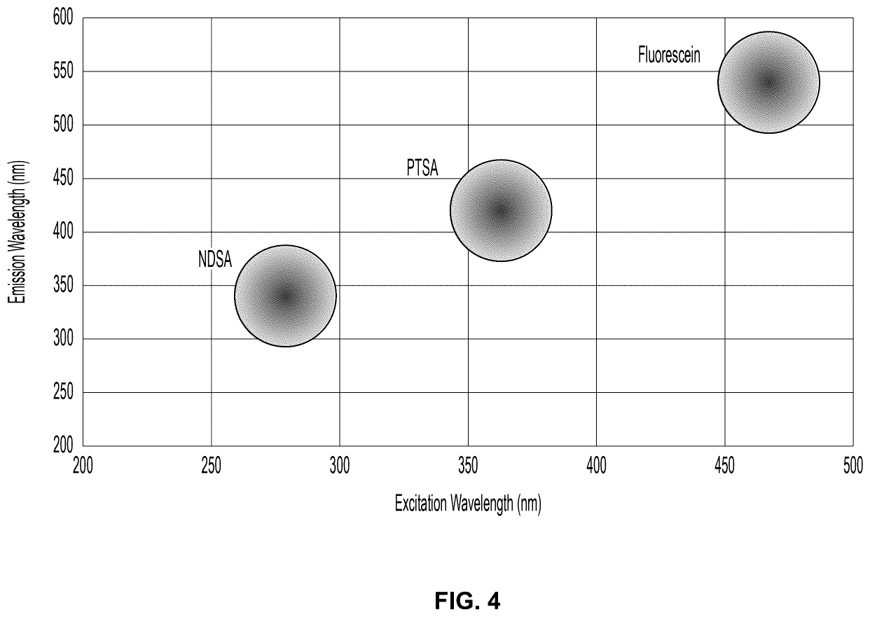

FIG. 4 is a plot showing inert tracer fluorometric response wavelengths at different excitation wavelengths for three example inert tracers. The three example inert tracers illustrated are NDSA (1,5-naphthalene disulfonic acid disodium salt, dihydrate (CAS #76758-30-0)); PTSA (1,3,6,8-pyrenetetrasulfonic acid (CAS #59572-10-0); and Fluorescein (CAS #2321-07-5). The example illustrates selection of different inert tracers with minor overlaps in excitation and emission spectra due to distant peaks.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components. For example, features described as controllers herein such as controller 114 using computing hardware physically co-located with membrane 102 or may be partially or fully physically remote from the membrane, such as implemented through a remote server, cloud-computing environment, or other physically remote computing device.

The techniques described in this disclosure may also be embodied or encoded in a computer-readable medium, such as a non-transitory computer-readable storage medium, containing instructions. Instructions embedded or encoded in a computer-readable storage medium may cause a programmable processor, or other processor, to perform the method, e.g., when the instructions are executed. Non-transitory computer readable storage media may include volatile and/or non-volatile memory forms including, e.g., random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

Various examples have been described. These and other examples are within the scope of the following claims.

1. A method for controlling addition of multiple chemical additives into a membrane separation process, the method comprising:
introducing a first membrane treatment liquid into a feed stream of a membrane separation process, the first membrane treatment liquid comprising a first membrane treatment chemical and a first inert tracer, wherein an amount of the first inert tracer is proportional to a concentration of the first membrane treatment chemical;
introducing a second membrane treatment liquid into the feed stream of the membrane separation process, the second membrane treatment liquid comprising a second membrane treatment chemical and a second inert tracer, wherein an amount of the second inert tracer is proportional to a concentration of the second membrane treatment chemical and the second inert tracer is different than the first inert tracer;
fluorometrically analyzing the feed steam to generate a fluorometric response of the first inert tracer and a fluorometric response of the second inert tracer;
determining the concentration of the first membrane treatment chemical in the feed stream based on the fluorometric response of the first inert tracer and determining the concentration of the second membrane treatment chemical in the feed stream based on the fluorometric response of the second inert tracer; and
contacting a membrane in the membrane separation process with the feed stream containing the first membrane treatment chemical and the second membrane treatment chemical, thereby generating a permeate stream and a concentrate stream.

2. The method of claim 1, further comprising:
controlling introduction of the first membrane treatment liquid to the feed stream based on a determined concentration of the first membrane treatment chemical; and
controlling introduction of the second membrane treatment liquid to the feed stream based on a determined concentration of the second membrane treatment chemical.

3. The method of claim 2, wherein:
controlling introduction of the first membrane treatment liquid to the feed stream based on the determined concentration of the first membrane treatment chemical comprises starting a pump introducing the first membrane treatment liquid into the feed stream, stopping the pump introducing the first membrane treatment liquid into the feed stream, or adjusting a delivery rate of the pump introducing the first membrane treatment liquid into the feed stream; and
controlling introduction of the second membrane treatment liquid to the feed stream based on the determined concentration of the second membrane treatment chemical comprises starting a pump introducing the second membrane treatment liquid into the feed stream, stopping the pump introducing the second membrane treatment liquid into the feed stream, or adjusting a delivery rate of the pump introducing the second membrane treatment liquid into the feed stream.

4. The method of claim 1, wherein the first membrane treatment chemical and the second membrane treatment chemical are selected from the group consisting of a biocide, an antiscalant, an acid, a base, an inline cleaner, and combinations thereof.

5. The method of claim 1, wherein:
the first membrane treatment chemical is a biocide; and
the second membrane treatment chemical is an antiscalant.

6. The method of claim 1, wherein the first inert tracer emits light at a first wavelength range in response to being excited, the second inert tracer emits light at a second wavelength range in response to being excited, and the first wavelength range does not overlap with the second wavelength range.

7. The method of claim 1, wherein the first inert tracer is naphthalene disulfonic acid disodium salt and the second inert tracer is 1,3,6,8-pyrene tetrasulfonic acid tetrasodium salt.

8. The method of claim 1, wherein fluorometrically analyzing the feed steam to generate the fluorometric response of the first inert tracer and the fluorometric response of the second inert tracer comprises:
obtaining a sample of the feed stream containing the first membrane treatment liquid and the second membrane treatment liquid via a side stream fluidly connected to a primary conduit conveying the feed stream to the membrane;
emitting, via one or more fluorometers, light at a first wavelength into the sample and thereby generating the fluorometric response of the first inert tracer and detecting the fluorescent response of the first inert tracer; and
emitting, via the one or more fluorometers, light at a second wavelength into the sample and thereby generating the fluorometric response of the second inert tracer and detecting the fluorescent response of the second inert tracer.

9. The method of claim 8, wherein the one or more fluorometers comprise a first fluorometer and a second fluorometer arranged in series or in parallel with each other.

10. The method of claim 1, wherein introducing the first membrane treatment liquid and introducing the second membrane treatment liquid comprises introducing the first membrane treatment liquid and introducing the second membrane treatment liquid at first and second injection locations, respectively, in series with each other.

11. The method of claim 1, further comprising passing the feed stream containing the first membrane treatment liquid and the second membrane treatment liquid through a mixer prior to fluorometrically analyzing the feed steam.

12. The method of claim 1, wherein the membrane is a reverse osmosis membrane.

13. A method for controlling addition of multiple chemical additives into a membrane separation process, the method comprising:
introducing a first membrane treatment liquid into a feed stream of a membrane separation process, the first membrane treatment liquid comprising a biocide and a first inert tracer, wherein an amount of the first inert tracer is proportional to a concentration of the biocide;
introducing a second membrane treatment liquid into the feed stream of the membrane separation process, the second membrane treatment liquid comprising an antiscalant and a second inert tracer, wherein an amount of the second inert tracer is proportional to a concentration of the antiscalant and the second inert tracer is different than the first inert tracer;
fluorometrically analyzing the feed steam to generate a fluorometric response of the first inert tracer and a fluorometric response of the second inert tracer;
determining the concentration of the biocide in the feed stream based on the fluorometric response of the first inert tracer and determining the concentration of the antiscalant in the feed stream based on the fluorometric response of the second inert tracer;
controlling introduction of the first membrane treatment liquid to the feed stream based on a determined concentration of the biocide; and
controlling introduction of the second membrane treatment liquid to the feed stream based on a determined concentration of the antiscalant;
contacting a reverse osmosis membrane in the membrane separation process with the feed stream containing the biocide and the antiscalant, thereby generating a permeate stream and a concentrate stream.

14. The method of claim 13, wherein the first inert tracer emits light at a first wavelength range in response to being excited, the second inert tracer emits light at a second wavelength range in response to being excited, and the first wavelength range does not overlap with the second wavelength range.

15. The method of claim 13, wherein the first inert tracer is naphthalene disulfonic acid disodium salt and the second inert tracer is 1,3,6,8-pyrene tetrasulfonic acid tetrasodium salt.

16. The method of claim 13, wherein fluorometrically analyzing the feed steam to generate the fluorometric response of the first inert tracer and the fluorometric response of the second inert tracer comprises:
obtaining a sample of the feed stream containing the first membrane treatment liquid and the second membrane treatment liquid via a side stream fluidly connected to a primary conduit conveying the feed stream to the reverse osmosis membrane;
emitting, via a first fluorometer, light at a first wavelength into the sample and thereby generating the fluorometric response of the first inert tracer and detecting the fluorescent response of the first inert tracer; and
emitting, via a second fluorometer, light at a second wavelength into the sample and thereby generating the fluorometric response of the second inert tracer and detecting the fluorescent response of the second inert tracer.

17. A system comprising:
at least one pump configured to introduce a first membrane treatment liquid and a second membrane treatment liquid into a feed stream of a membrane separation process, wherein the first membrane treatment liquid comprises a first membrane treatment chemical and a first inert tracer, the second membrane treatment liquid comprises a second membrane treatment chemical and a second inert tracer, and the second inert tracer is different than the first inert tracer;
a membrane configured to separate the feed stream into a permeate stream and a concentrate stream;
at least one fluorometer configured to fluorometrically analyze the feed stream to generate a fluorometric response of the first inert tracer and a fluorometric response of the second inert tracer; and
a controller communicatively coupled to the at least one pump and the at least one fluorometer, the controller being configured to:
determine a concentration of the first membrane treatment chemical in the feed stream based on the fluorometric response of the first inert tracer and determine a concentration of the second membrane treatment chemical in the feed stream based on the fluorometric response of the second inert tracer; and
control the at least one pump to adjust an addition rate of the first membrane treatment liquid to the feed stream based on a determined concentration of the first membrane treatment chemical and to adjust an addition rate of the second membrane treatment liquid to the feed stream based on a determined concentration of the second membrane treatment chemical.

18. The system of claim 17, wherein the at least one pump comprises a first pump fluidly connected to a source of the first membrane treatment liquid and a second pump fluidly connected to a source of the second membrane treatment liquid.

19. The system of claim 17, wherein the at least one fluorometer comprises:
a first fluorometer configured to emit light at a first wavelength into a sample of the feed stream and thereby generating the fluorometric response of the first inert tracer and detecting the fluorescent response of the first inert tracer; and
a second fluorometer configured to emit light at a second wavelength into the sample and thereby generating the fluorometric response of the second inert tracer and detecting the fluorescent response of the second inert tracer.

20. The system of claim 17, further comprising a mixer positioned downstream of an injection location where the at least one pump introduces the first membrane treatment liquid and the second membrane treatment liquid into the feed stream and upstream of the at least one fluorometer.
